(19) United States
(12) Patent Application Publication
(10) Pub. No.: US 2012/0239743 A1
(43) Pub. Date: Sep. 20, 2012

(54) APPARATUS AND METHOD FOR TRANSLATING SENSOR DATA INTO ANTHROPOMORPHIC STATUS AND CONTROL FOR SOCIAL NETWORKING PLATFORMS

(76) Inventors: Metin Ata Gunsay, Bluffdale, UT (US); Misty Merrell Gunsay, Bluffdale, UT (US)

(21) Appl. No.: 13/418,990

(22) Filed: Mar. 13, 2012

Related U.S. Application Data
(60) Provisional application No. 61/452,457, filed on Mar. 14, 2011.

(51) Int. Cl. G06F 15/16

(52) U.S. Cl. 709/204

(57) ABSTRACT

An apparatus and method, having one or more sensors and actuators, which monitor and control living organisms or machinery, a communication link from the sensor and actuators to an Internet access node, a data base and application software which converts sensor data, into anthropomorphic content which can be delivered to social networking platforms, such that the data and control functions can be presented to a human as a virtual living entity.

### CROSS-REFERENCE TO RELATED APPLICATIONS

This Application claims priority on prior filed U.S. Provisional Application No. 61/452,457, filed Mar. 14, 2011, and incorporates the same by reference herein in its entirety.

### FIELD OF INVENTION

The invention melds home and other monitoring with social networking utilizing an anthropomorphic paradigm.

### BACKGROUND OF THE INVENTION

Anthropomorphism is the attribution of human characteristics to animals, plants, or non-living things.

Social networks such as Facebook, MySpace and Twitter are becoming increasingly popular. Individuals use these sites to form communities to keep track of their friends, and receive status updates. Individuals are also spending increasingly more time in these sites and use them with the same frequency that they use email. As such, social networking platforms are a natural place to receive status data from sensors networks. Reformulating the sensor data into an anthropomorphic content makes the data more fun, entertaining, easier to digest, and places it where people are increasingly spending much of their time.

This invention relates to reformulating and translating data collected from one or more sensors or sensor networks into an anthropomorphic form such that it controls the behaviour and personality of a virtual friend, virtual pet or virtual life form on a social networking platform. A social networking platform could be a private or public network.

### SUMMARY OF THE INVENTION

A apparatus and method, having one or more sensors, which monitors and controls living organisms, objects, or machinery, a communication link from the sensor back to an Internet access node, a data base and application software which converts sensor data, into anthropomorphic content and status which can be delivered to social networking platforms, and presented as a virtual living entity to be communicated with and controlled.

This invention reformulates the sensor data into anthropomorphic content so that the data appears to come from a virtual friend. The anthropomorphic content is related to the underlying data, in a way that a human being can understand the status of the object which is being monitored by a sensor or sensor network. For example, if the sensors are monitoring a house plant, the anthropomorphic content could be in the form of text comments such as “I am thirsty” when the plant needs to be watered, or “I feel blue today”, if there isn't enough light for the plant.

In a factory, each piece of equipment could be represented as a virtual anthropomorphic entity, and post comments such as “I have a tummy ache” when the equipment needs to be serviced. This can also be extended to pets and animals. For example, when a dog that is being monitored with a sensor collar barks, this can be translated into comments such as “I feel lonely” or “intruder alert”. This content can be generated and then posted on the various social media platforms. In the case of home automation, a house in its entirety or rooms or appliances in the house could be represented as virtual anthropomorphic entities and post their status on a social networking platform. For example, a refrigerator could sense that there was no milk, and post a picture of itself a comment with “I′m in the mood for milk” on a social networking platform.

In addition to status updates, an anthropomorphized object can be controlled by members of the site by posting comments to the virtual entity. For example, if a house plant reports that it is thirsty, a user could send it the command “please have a drink” via the social networking platform. The application software would translate the message to a machine command, and relay it back to an actuator in order to water the plant.

The personality of the virtual entity could be selected from a predefined list. For example, it could be a famous person or celebrity, or the personality could be customized by the person. The frequency of status updates would be defined by the virtual entity's owner. Various sensor trigger points would be set up for each sensor related to each corresponding virtual entity. When the trigger point threshold is reached, a communication is generated according to the virtual entity's personality, and delivered to the targeted social network platform.

The virtual entities could become friends with any other member of the social network. For example a person could become friends with his neighbour's dog and get status updates and feed him treats with actuators, and then watch video of the dog eating the treats.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views. Some objects readily ascertainable include and are not limited to:
1. Users of social networking platforms can interact with pets, animals, plants, or inanimate objects as if they were human beings, receiving status and giving them commands.
2. Data is presented in a fun and entertaining format.
3. The data can be viewed and shared by multiple people.
4. Products based on this technology can be virally marketed.
5. Large amounts of data from factories, farms or other large sensor networks can be aggregated and displayed in a format more easily used and acted upon by human beings.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of the anthropomorphic sensor interface to social networking platforms according to the present invention.

FIG. 2 is a block diagram of the anthropomorphic sensor and control interface to social networking platforms according to the present invention.

FIG. 3 is a flow chart of the progression of data through the entire system from sensors to the social networking platform, to the actuators.

### DETAILED DESCRIPTION OF THE PREFERRED EMBODIMENT

With reference now to the drawings, the preferred embodiments of the apparatus and method are herein described. It should be noted that the articles “a”, “an”, and “the”, as used in this specification, include plural referents unless the content clearly dictates otherwise.

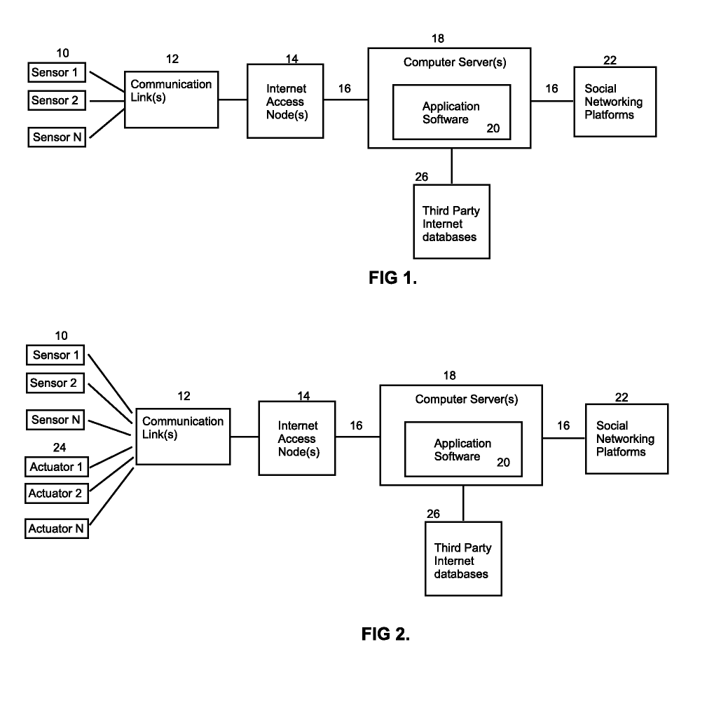

With reference to FIG. 1, a sensor, or multiple sensors, 10 receive data from an object that is being monitored. For example, the object could be a piece of machinery, objects, the weather, a pet, an animal, or a plant. Data received would vary, dependent upon the type of object monitored. For instance, a pet, such as a dog, could be monitored for food and water levels, ambient temperature, and barking behaviour. A plant could be monitored for ambient temperature, humidity, and sunlight levels, soil moisture, soil nutrients, or even pot position as a guard against tipping. This data is transferred via one or more communication links 12 to one or more Internet access nodes. These links could be wired or wireless links, such as but not limited to: USB, RS232, RF, infra red, etc. The purpose of the node is merely to allow the sensors access to the Internet 16, as sensors themselves usually do not have intrinsic Internet capability. The access node then transmits the data to one or more internet servers 18, which have greater processing capability. These servers have application software 20 running. The application software would not be limited to input only from sensors, but could also receive and act upon other information from various other sources on the Internet 26, such as weather information, or any other useful information which can be derived from third party sources.

The application software aggregates and stores the sensor data and other data from Internet sources by user accounts. Typically, a user will set up an account for their virtual entity through a user interface, and on the social network platform of their choice. Alternatively, account set up could be implemented for both systems through a single account set up on one system, whether it be through the social network platform's interface, or a on a separate server. A typical account would allow the user to select sensors, and other applicable information available on the internet, sensor and data trigger points and the actions to be performed when a trigger threshold is realized, the object being monitored, the personality type of one or more virtual anthropomorphic entities, and the frequency and schedule of the content delivery, and the target to which the content will be delivered. Note that user could select the entities' personalities from a list of standard personalities, or completely or partially customize the entities' personalities. Also note that the application software could generate periodic comments scheduled by the scheduler alone without any change to sensor inputs.

The software will aggregate and store sensor data into the appropriate account for the appropriate virtual entity. The server will translate this data into anthropomorphic content such as text, pictures, video, audio, and/or touch to be transmitted to and posted on various social media networks 22.

A block diagram of an alternate embodiment is described in FIG. 2. It is identical to FIG. 1 with the addition of actuators 24. In this embodiment a human can send control signals to the actuators by posting comments or other human communications to the social network's interface, and these commands are in turn passed to the application software 20. The application software translates the commands to machine understandable commands and relays these commands to the actuators via the Internet access nodes, and various communication links. The application software can also respond directly to the commands that it receives by posting responses back to the social networking platform. The scheduler could also perform routine control of the actuators without the need for user input.

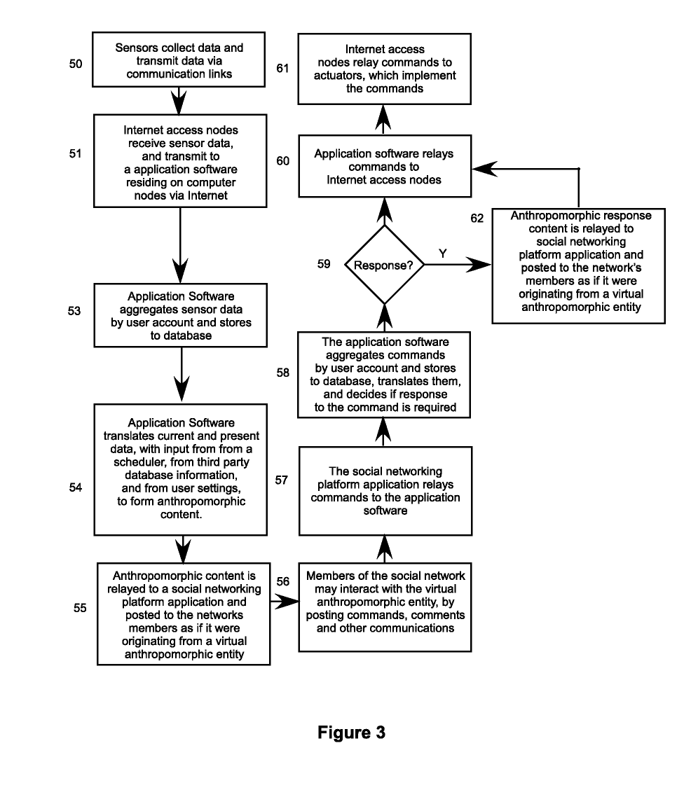

A flow chart is described in FIG. 3. In step 50 the sensors receive data and transmit this data via one or more communication links, to one or more Internet access nodes. Note that alternatively the sensors could be wired directly for internet access, and then a separate access node would be unnecessary. In step 51 the access nodes relay data to application software that resides on one or more computer servers. In this age of cloud computing, software applications can be spread across multiple servers in server farms. In step 53 the sensor data is sorted, aggregated and stored into a database by user account and by virtual anthropomorphic entity. In step 54 the sensor data together with information from other content available on the Internet, and user settings, personality settings, and scheduler settings the data is translated and into anthropomorphic content. The application software takes into account the degree of urgency of the sensor data, coupled with the desired frequency and selected schedule of status updates, to decide when and if a post of content should be made. The application software takes into account the desired personality of the virtual entity when creating the content. Each virtual entity can have various responses stored in a databases and when one or more sensors' trigger point thresholds are reached or as dictated by the scheduler internal to the application software and set up by the user, the appropriate response is generated from the list of responses appropriate to the selected virtual entity, and indexed by the sensors' numerical values.

In step 55 the application software relays the anthropomorphic content to the social network platform. Many platforms such as Facebook have an open application architecture that allows third party developers to interface with the social network platform, in posting and receiving content. This content can be viewed and acted upon by human users as in step 56. If the user can then interact with the virtual entity as he would a human member of the site, and post communications to the virtual entity. These communications are relayed from the social network platform back to the application server as in step 57. The application software aggregates, stores, translates, and processes the commands by user account and virtual entity. In step 65, the application software may decided that a response is necessary to the user for the given command and based on the status of the sensors, and as in step 62 issue a response back to the social network platform. For example, it the response could be as simple as posting the text message “thank you”, or “I'll do it”. As for translation, common list of acceptable commands could be made accessible to the social networking site members, and these common phrases can be compared against a database of potential phrases with their corresponding translation to a machine command and response. Also advanced language processing algorithms could be used with artificial intelligence systems to translate the communications to a command set that computer systems can more easily process.

In steps 60 and 61, the application software relays commands to the actuators via internet access nodes communication links, and the actuators act upon the commands.

The present invention has been described as utilizing a social network platform. While many of these platforms are understood to be available to the public, it is then, to be understood that a private network platform may also be utilized in the application of this invention. Such use would thereby restrict information to those individuals who may have a legitimate need to know, as opposed to the public in general. Such situations would include a private network for a company that could be utilized to monitor operating equipment.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. An apparatus for providing feedback to a user in an anthropomorphic presentation, the apparatus comprising:
a. at least one sensor,
b. at least one computer node, having Internet access capability,
c. at least one communication link connecting the at least one computer node to the at least one sensor,
d. at least one computer server node, also linked to the Internet, which receives forwarded sensor data, and
e. at least one software application hosted by the server node, wherein the at least one software program interprets data into anthropomorphic content, translating the underlying status of the sensors as human emotions, thoughts, feelings and sensations of a virtual intelligent entity such that a human can understand the status of the underlying sensors and periodically delivers said anthropomorphic content with the use of a scheduler to external social networking platforms presenting the data as a virtual human, pet or other virtual intelligent entity.

2. The apparatus of claim 1, the at least one software application providing a list of selectable predefined personalities usable by the software application to interpret the data into anthropomorphic content.

3. The apparatus of claim 1 wherein at least one sensor monitors a plant.

4. The apparatus of claim 1 wherein at least one sensor monitors an animal.

5. The apparatus of claim 4 wherein at least one sensor is attached to an animal's collar.

6. The apparatus of claim 1 wherein at least one sensor monitors machinery.

7. The apparatus of claim 1, further comprising at least one actuator, operatively connected to the apparatus, thereby providing opportunity for the apparatus to interface with an environment.

8. A method for providing feedback to a user in an anthropomorphic presentation, the apparatus comprising:
a. a step of connecting sensors to an object,
b. a step of transmitting sensor data to an Internet access point through a communication link,
c. a step of transmitting data from the Internet access point to at least one server computer which hosts server application software,
d. a step of connecting to at least one social networking platform periodically with the use of a scheduler; and,
e. a step of delivering the anthropomorphic content to the at least one social networking platform;
wherein the at least one software program interprets data into anthropomorphic content, translating the underlying status of the sensors as human emotions, thoughts, feelings and sensations of a virtual intelligent entity such that a human can understand the status of the underlying sensors and periodically delivers said anthropomorphic content with the use of a scheduler to external social networking platforms presenting the data as a virtual intelligent entity.

9. The method of claim 8, further comprising a step of the at least one software application providing a list of selectable predefined personalities usable by the software application to interpret the data into anthropomorphic content.

10. The method of claim 8 wherein at least one sensor monitors a plant.

11. The method of claim 8 wherein at least one sensor monitors an animal.

12. The method of claim 11 wherein at least one sensor is attached to an animal's collar.

13. The method of claim 8 wherein at least one sensor monitors machinery.

14. The method of claim 8, further comprising
a. a step of at least one the member of the at least one social network interacting with the virtual entity through a social networking interface,
b. a step of the application software translating this interaction into at least one machine understandable command and relaying the at least one command to the Internet access point and sending at least one acknowledgement in the form of anthropomorphic content back to the social networking platform which in turn posts the at least one acknowledgment,
c. a step of the Internet access point relaying the at least one command to an actuator,
d. a step of the actuator implementing the command.
